(19) United States
(12) Patent Application Publication
(10) Pub. No.: US 2012/0131826 A1
(43) Pub. Date: May 31, 2012

(54) SUPPORT STAND AND DISPLAY DEVICE USING SAME

(75) Inventor: BIN DAI, ShenZhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/975,777

(22) Filed: Dec. 22, 2010

(30) Foreign Application Priority Data
Nov. 30, 2010 (CN) 201010565708.3

(51) Int. Cl. G09F 7/00; F16M 13/00

(52) U.S. Cl. 40/597; 248/158

(57) ABSTRACT

A support stand includes a base, a suction assembly, and a connecting plate. The suction assembly includes a suction cup, a receiving seat, and an adjusting member. The suction cup forms a connecting shaft. The connecting shaft extends through the base and engages with the adjusting member, thus positioning the suction cup in the receiving seat. The connecting plate connects the suction assembly to the base. A display device using the support stand is also provided.

### BACKGROUND

1. Technical Field

The present disclosure relates generally to device support and, more particularly, to a support stand for a display device.

2. Description of Related Art

The tilt angle of an LCD panel of an LCD device can often be adjusted via a support stand.

Such a support stand often includes a base, a connecting plate, a connecting seat, a first hinge, and a second hinge. The connecting seat is rotatably connected to the connecting plate via the first hinge, and the connecting plate is rotatably connected to the base via the second hinge. The connecting seat is connected to a fixing portion of the LCD panel via a plurality of fasteners.

However, in assembly/disassembly of the LCD panel to the connecting seat, each of the fasteners must be individually adjusted. In addition, the LCD panel needs the fixing portion corresponding to the connecting seat. Therefore, the support stand has a complex structure.

Therefore, there is room for improvement within the art.

### BRIEF DESCRIPTION OF THE DRAWINGS

The elements in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of an embodiment of a display device including a support stand and a display device.

FIG. 2 is an enlarged, isometric view of the support stand of FIG. 1.

FIG. 3 is an exploded, isometric view of the support stand of FIG. 2.

### DETAILED DESCRIPTION

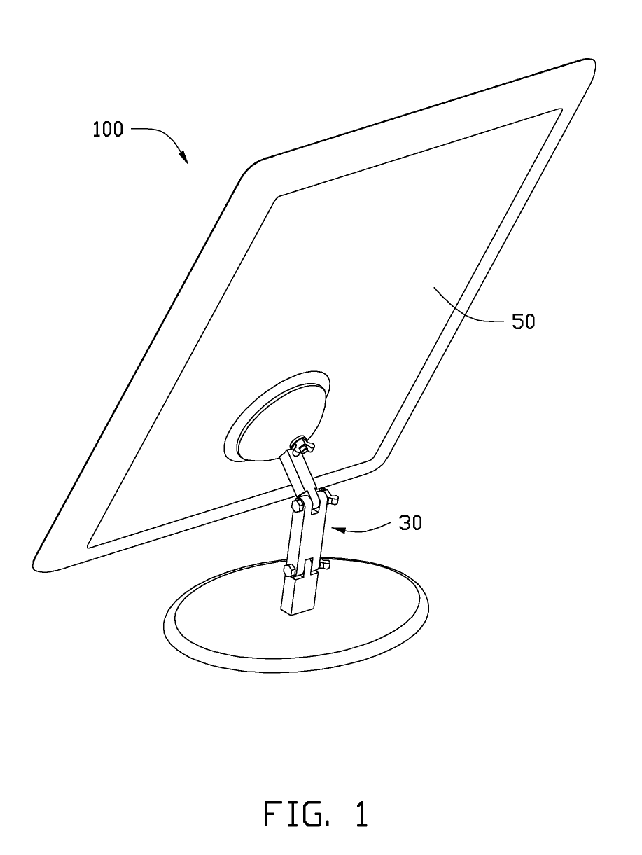

Referring to FIG. 1, an embodiment of a display device 100 includes a support stand 30 and a display panel 50. In the illustrated embodiment, the display panel is an LCD panel.

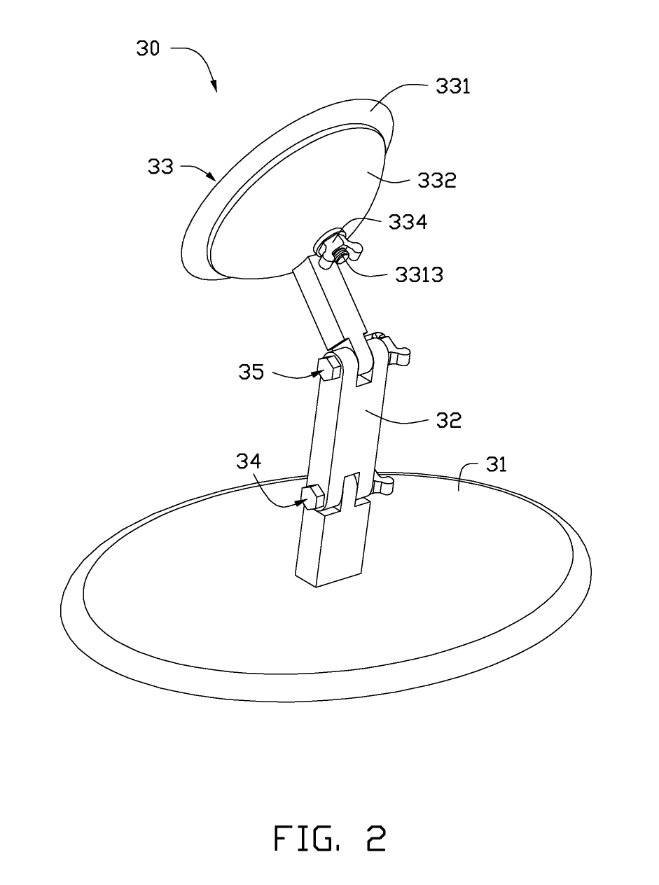

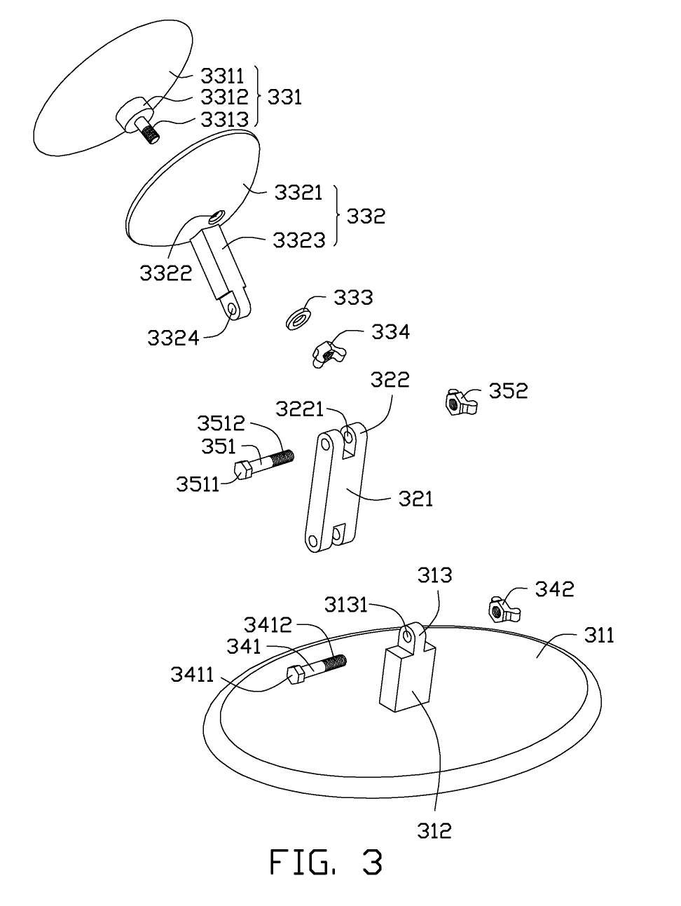

Referring to FIGS. 2 and 3, the support stand 30 includes a base 31, a connecting plate 32, a suction assembly 33, a first hinge 34, and a second hinge 35.

The base 31 includes a bottom plate 311 and a support portion 312 extending upwards from a center portion of the bottom plate 311. A restricting portion 313 is formed on a top end of the support portion 312. The restricting portion 313 defines a through hole 3131. In the illustrated embodiment, the bottom plate 311 is a substantially circular plate.

The connecting plate 32 includes a substantially rectangular main portion 321 and two pairs of connecting portions 322 extending outwardly from two opposite edges of the main portion 321, respectively. Each pair of connecting portions 322 faces each other and defines a connecting hole 3221 substantially coaxial with each other.

The suction assembly 33 includes a suction cup 331, a receiving seat 332, a washer 333, and an adjusting member 334. The suction cup 331 includes a substantially hemispherical suction portion 3311 and a spacer portion 3312 extending from the suction portion 3312. A connecting shaft 3313 is formed at an end of the spacer portion 3312 away from the suction portion 3311. In the illustrated embodiment, the suction cup 331 is made of silicone rubber. The connecting shaft 3313 forms a plurality of threads. The receiving seat 332 includes a substantially hemispherical receiving portion 3321 corresponding to the suction portion 3311, a radius of which is less than that of the suction portion 3311. A tip of the receiving portion 3321 defines an assembly hole 3322. The receiving seat 332 further forms a support pole 3323 adjacent to the assembly hole 3322. The support pole 3323 defines a through hole 3324 at an end away from the receiving portion 3321. In the illustrated embodiment, the washer 333 is a substantially circular washer, and the adjusting member 334 is a threaded retainer.

The first hinge 34 includes a first shaft 341 and a first fastener 342. A shaft cap 3411 and a threaded portion 3412 are formed on opposite ends of the first shaft 341. In the illustrated embodiment, the first fastener 342 is a threaded retainer.

The second hinge 35 includes a first shaft 351 and a first fastener 352. A shaft cap 3511 and a threaded portion 3512 are formed on opposite ends of the second shaft 351. In the illustrated embodiment, the second fastener 352 is a threaded retainer.

In assembly of the support stand 30, the first shaft 341 extends through the connecting hole 3221 of one connecting portion 322, the through hole 3131 of the restricting portion 313, and the connecting hole 3221 of another connecting portion 322. The first fastener 342 is assembled on the threaded portion 3412 of the first shaft 341 such that the connecting plate 32 is connected to the base 31. The second shaft 351 extends through the connecting hole 3221 of one connecting portion 322, the through hole 3324 of the support pole 3323, and the connecting hole 3221 of another connecting portion 322. The second fastener 352 is assembled on the threaded portion 3512 of the second shaft 351 such that the receiving seat 332 is connected to the connecting plate 32. The connecting shaft 3313 of the suction cup 331 extends through the assembly hole 3322 of the receiving seat 332, the washer 333, and the adjusting member 334. The suction cup 331 can be positioned in the receiving seat 332 by rotating the adjusting member 334.

In assembly of the display device 100, the display panel 50 is attached to the suction cup 331. Then the adjusting member 334 is rotated such that the connecting shaft 3313 pulls the suction portion 3311 to expand towards the tip of the receiving portion 3321. Thus, air pressure in the suction portion 3311 is lower than that of outside. The display panel 50 is positioned on the support stand 30 via a suction force generated by the air pressure difference between inside and outside the suction portion 3311. The suction cup 331 can fix display panels 50 with different weights by rotation of the adjusting member 334.

In use, a tilt angle of the display panel 50 can be adjusted by rotating the first and second fasteners 342, 352 to loosen the first and second shafts 341, 351, and then rotating the connecting plate 32 and the support pole 3323. After the display panel 50 is adjusted to a desired tilt angle, the first and second fasteners 342, 352 are rotated to lock the first and second shafts 341, 351. In disassembly of the display panel 50 from the support stand 30, the adjusting member 334 is rotated to eliminate suction force of the suction cup 331. Finally, the display panel 50 is disassembled from the suction cup 331.

The support stand 30 grasps the display panel 50 tightly by the suction cup 331, and the display panel 50 is assembled/disassembled by rotation of the adjusting member 334, thus the support stand 30 has a simple structure and operates easily. It should be appreciated that the base 31, the first hinge 34, and the second hinge 35 may have other structures, such as, for example, the first hinge 34 further comprises an elastic member sleeved on the first shaft 341.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A support stand, comprising:
a base;
a suction assembly comprising a suction cup, a receiving seat, and an adjusting member, wherein the suction cup forms a connecting shaft extending through the receiving seat and engaging with the adjusting member, thereby positioning the suction cup in the receiving seat; and
a connecting plate connecting the suction assembly to the base.

2. The support stand of claim 1, wherein the suction cup further comprises a substantially hemispherical suction portion, the receiving seat comprises a substantially hemispherical receiving portion corresponding to the suction portion, and a radius of the receiving portion is smaller than that of the suction portion.

3. The support stand of claim 2, wherein the suction cup further comprises a spacer portion extending from the suction portion, and the connecting shaft is formed on the spacer portion.

4. The support stand of claim 1, wherein the connecting shaft forms a plurality of threads, and the adjusting member is a threaded retainer threadedly engaged on the connecting shaft.

5. The support stand of claim 1, further comprising a first hinge connecting the base to the connecting plate.

6. The support stand of claim 5, wherein the first hinge comprises a first shaft and a first fastener, the first shaft extends through the base and the connecting plate, and engages with the first fastener.

7. The support stand of claim 1, further comprising a second hinge connecting the suction assembly to the connecting plate.

8. The support stand of claim 7, wherein the receiving seat forms a support pole, the second hinge comprises a second shaft and a second fastener, and the second shaft extends through the support pole and the connecting plate, and engages with the second fastener.

9. A display device, comprising:
a support stand, comprising:
a base;
a suction assembly comprising a suction cup, a receiving seat, and an adjusting member, wherein the suction cup forms a connecting shaft extending through the receiving seat and engaging with the adjusting member, thereby positioning the suction cup in the receiving seat; and
a connecting plate connecting the suction assembly to the base; and
a display panel held by the suction cup.

10. The display device of claim 9, wherein the suction cup further comprises a substantially hemispherical suction portion, the receiving seat comprises a substantially hemispherical receiving portion corresponding to the suction portion, and a radius of the receiving portion is smaller than that of the suction portion.

11. The display device of claim 10, wherein the suction cup further comprises a spacer portion extending from the suction portion, and the connecting shaft is formed on the spacer portion.

12. The display device of claim 9, wherein the connecting shaft forms a plurality of threads, and the adjusting member is a threaded retainer threadedly engaged on the connecting shaft.

13. The display device of claim 9, further comprising a first hinge connecting the base to the connecting plate.

14. The display device of claim 13, wherein the first hinge comprises a first shaft and a first fastener, the first shaft extends through the base and the connecting plate, and engages with the first fastener.

15. The display device of claim 9, further comprising a second hinge connecting the suction assembly to the connecting plate.

16. The display device of claim 15, wherein the receiving seat forms a support pole, the second hinge comprises a second shaft and a second fastener, and the second shaft extends through the support pole and the connecting plate, and engages with the second fastener.
